(19) United States
(12) Patent Application Publication
(10) Pub. No.: US 2004/0217050 A1
(43) Pub. Date: Nov. 4, 2004

(54) Solids separation system for well flowback

(75) Inventors: David A. Schmidt, Houston, TX (US); Thomas E. Neal, Hitchcock, TX (US); John W. McCaskill, Jersey Village, TX (US)

Correspondence Address: Elizabeth R. Hall & Associates, P.C., 1722 Maryland Street, Houston, TX, 77006, US

(73) Assignee: Power Chokes, L.P., Cypress, TX

(21) Appl. No.: 10/781,186

(22) Filed: Feb. 17, 2004

Related U.S. Application Data
(60) Provisional application No. 60/467,307, filed on May 2, 2003.

(51) Int. Cl. B01D 17/038

(52) U.S. Cl. 210/512.1; 166/75.12; 210/109

(57) ABSTRACT

The invention contemplates a simple, easy to operate hydrocyclone separation system that removes the heavy phase containing the produced solids intermittently, rather than continuously. The desirable, lighter portion of the well production, from which the aggressive solids of the propant have been removed, is continuously separated from the well production and treated by the existing surface fluid conditioning equipment at the well site. The heavy phase is collected in the bottom of the hydrocyclone. The outlet for the heavy phase flow stream is normally closed by a shutoff valve and is only dumped when the separator is full. The solid containing fluid exiting from the heavy phase outlet valve is passed through a standard oilfield hydraulic choke in order to reduce its pressure sufficiently so that normal piping and solids collection equipment can be used to handle the dumped fluid.

### CROSS REFERENCE TO RELATED APPLICATIONS

This application claims priority to pending U.S. Patent Application Ser. No. 60/467,307 (Attorney Docket Number PC-P002V, filed May 2, 2003 by David A. Schmidt, et al. and entitled “Solids Separation System for Well Flowback.”

### BACKGROUND OF THE INVENTION

1. Field of the Invention

The present invention relates to a centrifugal separation system that can be used to separate solids from very high pressure flows emanating from a petroleum well. More particularly, the apparatus and process of the present invention are configured to permit avoidance of continuous outflow of the heavy phase of the centrifuge output, thereby reducing wear of the flow components.

2. Description of the Related Art

For wells that are to be treated by hydraulic fracturing, it is necessary to entrain the propant in a fluid that will support the grains of the propant. This fracture fluid with its propant are then injected into the formation to be treated in order to fracture the formation and fill its fractures with a highly permeable layer of propant. In order to resist crushing under the high crack closure pressures that may result in a treated formation, the propant is often a highly abrasive material, such as sintered bauxite, sand, or other aggressive material. Following the completion of the fracturing operation, the well is backflowed in order to recover the fracturing fluid and then initiate production. When this happens, large amounts of propant are produced out of the well, along with the backflowing fracturing fluid and produced well fluids. Because the fracture propant is often very aggressive and damaging to the components in the production fluid handling system, it is highly desirable to separate this propant from the fluid coming out of the well before it damages downstream components.

Currently the propant is separated from the produced fluids emanating from the well using a continuous flow centrifugal separation system. This separation system is feasible because the propant is typically significantly denser than the fluids. Centrifugal separators based on fluid hydrocyclones are currently used to desilt drilling fluids. These hydrocyclones generally have a conical form with incoming fluid injected tangentially into the conical chamber at its point of largest diameter. The cone of the hydrocyclone is mounted with its small end down and its axis vertical. The centrifugal spin imparted to the fluid entering into the hydrocyclone causes the heavier constituents in the fluid to move to the outer diameter of the cone. The heavy components gradually migrate downwardly in the cone under the influence of gravity to be withdrawn from a dense fluid phase outflow passage at the bottom of the hydrocyclone. The lighter components of the fluid entering the cone are concentrated in the center of the cone at its upper end, where the light fluid phase is withdrawn upwardly through a light phase outflow passage at the top of the hydrocyclone. The operation of the centrifugal hydrocyclone separator is continuous and is performed at low pressure for drilling operations.

The fluid hydrocyclone separator approach to separation of denser solids from admixed fluid is successful because the process can typically be run at low pressure. The hydrocyclone separator system often uses plastic hydrocyclone cones and piping. Plastics, such as polyethylene or urethane, are commonly used since they are resistant to fluid and sand erosion and are inexpensive.

The prior hydrocyclone centrifugal separator equipment is not efficient for separating fluids under high pressures. Thus, it cannot be successfully used for separating well fluids from producing high pressure wells if the separator is to be located in the optimal position upstream of the primary production equipment. This is primarily because the surface well pressures can be very high, even exceeding 15,000 psi in some cases. Additionally, if a hydrocyclone were continuously operated in the conventional manner, considerable desirable well production product would be discarded along with the undesirable production product in the relatively unconcentrated heavy phase solids.

Thus, a need exists for a solids separation device that can be used in high pressure well conditions to separate produced solids from the desirable well production in a safe, effective, and economical manner.

### SUMMARY OF THE INVENTION

The invention contemplates a simple, easy to operate hydrocyclone separation system that removes the heavy phase containing the produced solids intermittently, rather than continuously. The desirable, lighter portion of the well production, from which the aggressive solids of the propant have been removed, is continuously separated from the well production and then is treated by the existing surface fluid conditioning equipment at the well site.

The heavy phase is collected in the bottom of the hydrocyclone, which is cylindrical in this case. The outlet for the heavy phase flow stream is normally closed by a shutoff valve, but when the separator is found to be full, as can be determined by a nuclear density gauge or by weight of the separator, then the valve can be opened to dump the heavy phase, which is quite concentrated at the time of the valve opening. The solid containing fluid exiting from the heavy phase outlet valve is passed through a standard oilfield hydraulic choke in order to reduce its pressure sufficiently so that normal piping and solids collection equipment can be used to handle the dumped fluid.

One aspect of the present invention is a solids separation system comprising a material entry line; an entry valve attached to the entry line; a hydrocyclone comprising a tubular body having a top end cap and a bottom end cap, a first inlet proximal to the top end cap, a spin can positioned within a top end of the tubular body below the top end cap, and an outlet tube transversing the spin can; a fluid outlet line having one end attached to the outlet tube; a solids outlet line exiting a bottom end of the hydrocyclone; a solids exit valve in fluid communication with the solids outlet line on a first end; a choke in fluid communication with the solids outlet line when the solids exit valve is open; and a solids exit line attached to the choke.

Another aspect of the present invention is a solids separation system comprising a material entry line; an entry valve attached to the entry line; a hydrocyclone comprising a tubular body having a top end cap and a bottom end cap, a first inlet proximal to the top end cap, a spin can positioned within a top end of the tubular body below the top end cap, the spin can having an aperture aligned with the first inlet, and an outlet tube transversing the spin can and extending into the tubular body below the spin can; a fluid outlet line having one end attached to the outlet tube; a fluid exit valve connected to the fluid outlet line on a first end and to a fluid exit line on a second end; a solids outlet line exiting a bottom end of the hydrocyclone; a solids exit valve in fluid communication with the solids outlet line on a first end; a choke in fluid communication with the solids outlet line when the solids exit valve is open; a solids exit line attached to the choke; and an actuator attached to the choke on an opposed side of the choke from the solids exit line.

Another aspect of the present invention is that the hydrocyclone is constructed in a manner wherein it may be reversed by inverting it and reconnecting the inlet to the other end whenever its upper end becomes excessively worn.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an oblique view of the solids separation system mounted in a skid package;

FIG. 2 is an oblique view of the solids separation system corresponding to the view in FIG. 1, but with the skid package removed for clarity;

FIG. 3 is an oblique view of the solids separation system with the skid package removed and from the opposite side of the view shown in FIG. 2;

FIG. 4 is a profile view of the solids separation system with the skid package removed;

FIG. 5 is a profile view of the hydrocyclone of the solids separation system;

FIG. 6 is a top view of the hydrocyclone shown in FIG. 5;

FIG. 7 is a horizontal cross-sectional view of the hydrocyclone taken along section line 7-7 of FIG. 5;

FIG. 8 is a horizontal cross-sectional view of the hydrocyclone taken along section line 8-8 of FIG. 5;

FIG. 9 is a vertical longitudinal cross-sectional view of the hydrocyclone taken along section line 9-9 of FIG. 5;

FIG. 10 is a profile view of the spin chamber and its supporting light phase outlet tube, both mounted within the hydrocyclone;

FIG. 11 is a vertical cross-sectional view of the spin chamber and its supporting light phase outlet tube taken along section line 11-11 of FIG. 10; and

FIG. 12 is a horizontal cross-sectional view taken through the flow path of the heavy phase fluid dump portion of the solids separation system.

### DESCRIPTION OF THE PREFERRED EMBODIMENTS

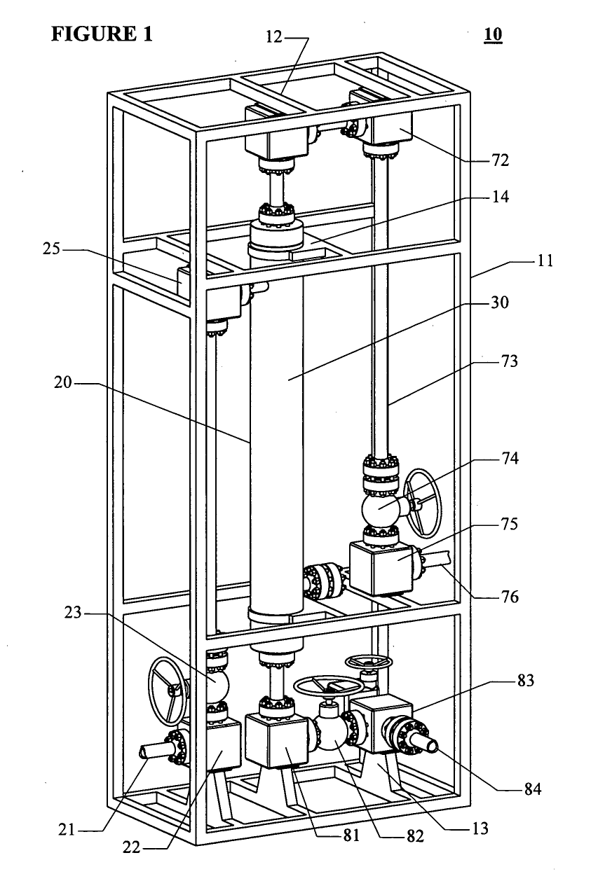

Referring to FIG. 1, the solids separation system 10 is shown to consist of a rectangular prismatic perimeter skid frame package 11 that mounts the flow components of the solids separation system flow circuitry 20. As shown herein, the skid frame is preferably fabricated from rectangular steel tubing, with conventional steel structural fabrication crossbar mountings 12, pedestal mountings 13, and saddle mountings 14 being used to mount the elements of the flow circuitry 20. Alternatively, the frame may be constructed of other metals or other steel shapes, if desirable for reasons of weight or corrosion.

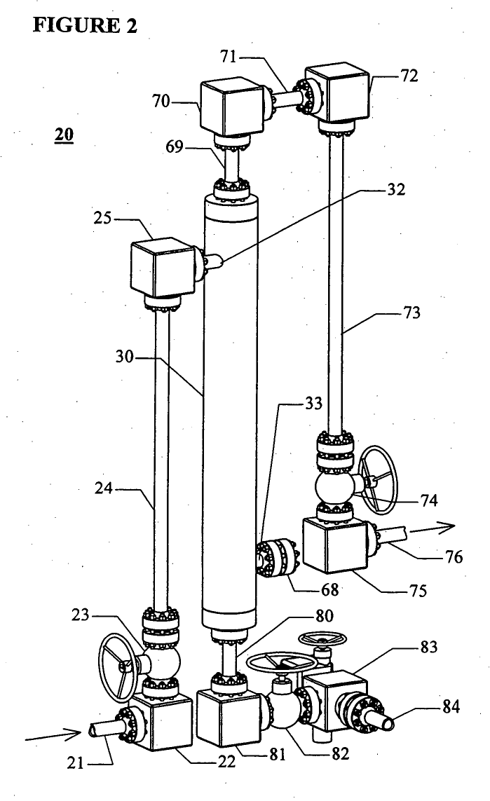

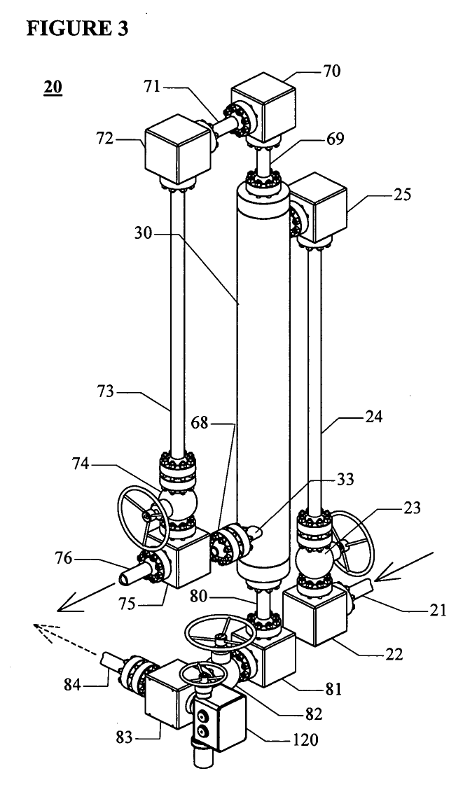

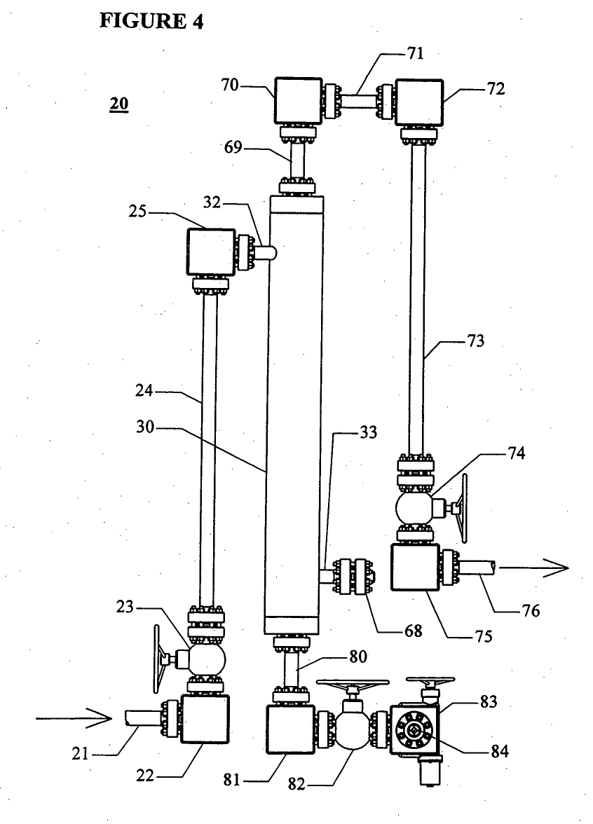

Referring to FIGS. 2, 3, and 4, the hydraulic circuit components are shown in a view corresponding to that of FIG. 1, but with the framing removed for clarity. The high pressure flow from the wellhead enters the solids separation system through horizontal flanged high pressure entry line 21, which is connected to rectangular elbow block 22 by means of a group of bolts arranged in a bolt circle and with a high pressure API Type RX metal ring gasket 46 therebetween.

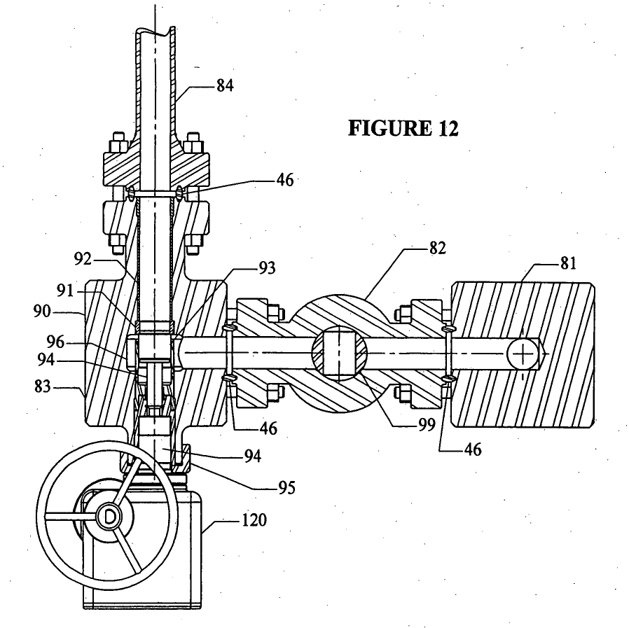

The elbow block 22 contains a flow passage having about a 90° bend in it. The ring gasket is engaged in identical annular ring gasket grooves 45 on the opposed mating faces of the connection. This type connection is used on all of the hydraulic connections of this device, and a typical connection is shown in cross-section in FIG. 12.

Connected to the upward flow outlet of elbow block 22 is a high pressure manually operated ball valve 23, with flanged vertical inlet line 24 connected to the upper end of the valve 23. The ball valve 23 is normally open. Herein ball valves are shown, but tapered plug valves or gate valves may also be used satisfactorily for this application. All the ball valves 23, 74, and 82 shown herein are substantially identical.

A second elbow block 25 is connected to the upper end of the inlet line 24 and diverts the flow back to horizontal. Elbow blocks 22, 25, 70, 72, 75, and 81 are all constructed similarly. The outlet of elbow block 25 is connected to flanged tangential flow inlet 32 of the hydrocyclone 30. The inlet 32 is located slightly below the upper end of the hydrocyclone 30. Slightly above the bottom end of the hydrocyclone in a mirror image location about the hydrocyclone horizontal midplane, but facing in an opposed direction is alternate tangential flow inlet 33, which is capped with blind flange 68. At the upper end of hydrocyclone 30 is light phase flow outlet tubular pup joint 69, which is connected to elbow block 70 on the upper end of pup joint 69.

Elbow block 70 turns the flow horizontally, where an interconnected second pup joint 71 carries it to another sequentially interconnected elbow block 72. Exiting flanged flow line 73 is attached to the bottom end of elbow block 72 and carries the light end flow downwardly to serially interconnected ball valve 74, which is normally open. Another elbow block 75 is connected to the outlet end of ball valve 74 and serves to turn the exiting light phase flow horizontally. The horizontal outlet flanged line 76 is interconnected to elbow block 75 and serves to convey the separated light phase well fluid to the conventional wellhead treatment equipment at the well location.

At the bottom end of hydrocyclone 30 is the outlet for the heavy phase that is intermittently flowed from the separator system 20. Vertical flanged pup joint 80 is attached to the bottom end of the hydrocyclone 30 and is in turn connected on its bottom end to elbow block 81. The exiting stream from elbow block 81 flows horizontally into interconnected, normally closed ball valve 82. Connected to the outlet of ball valve 82 is oilfield hydraulic choke 83, which is connected in turn on its outlet end to horizontal flanged dump line 84.

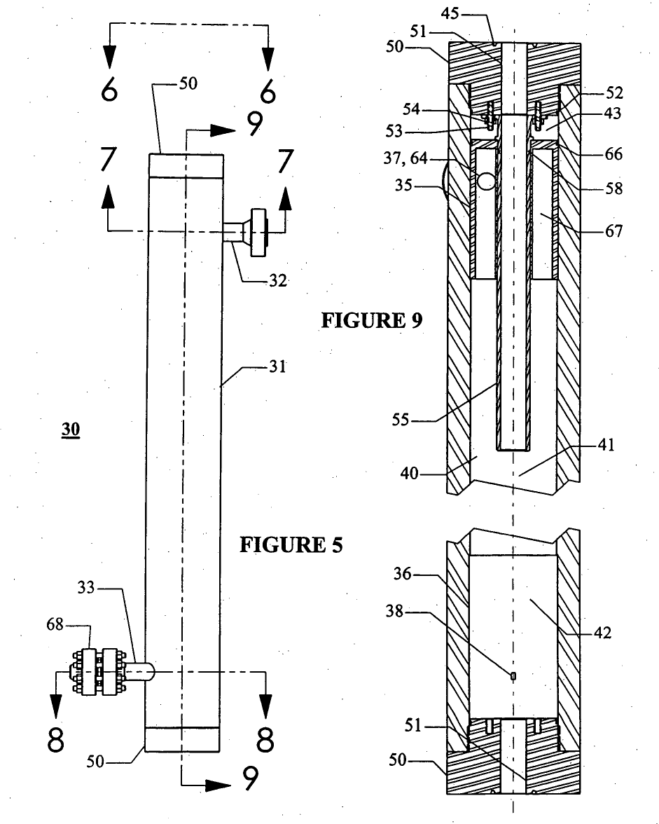

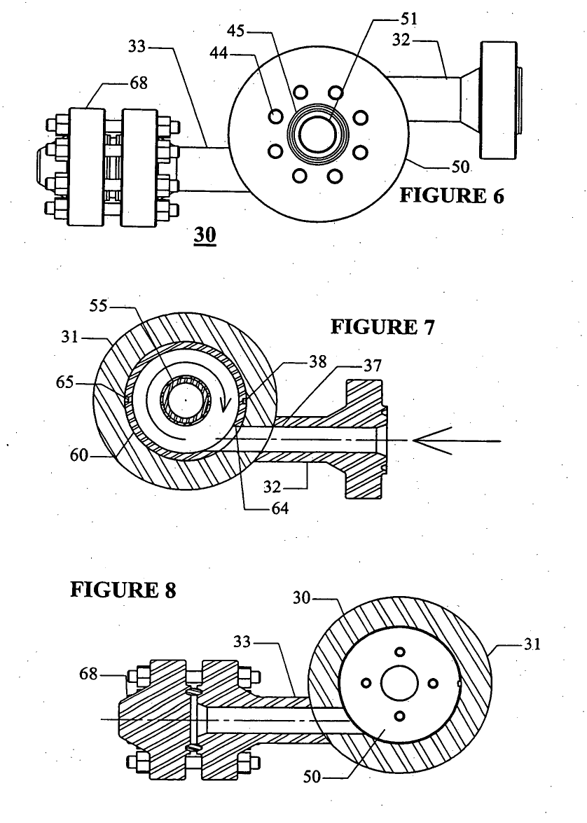

Referring to FIGS. 5 to 11, the details of the hydrocyclone can be seen. The hydrocyclone is cylindrical and is vertically mounted. The hydrocyclone 30 is constructed so that the body tube 31 can be inverted and reused when the upper inlet end of the hydrocyclone becomes excessively worn. The body tube 31 of hydrocyclone assembly 30 is a very heavy wall cylindrical tube having substantially identical upper and lower ends that are rotated 180° about the body tube longitudinal axis relative to each other. The upper and lower transverse distal ends of body tube 31 are provided with female threaded connections by which end caps 50 can be threadedly connected. Immediately inward of the threads in body tube 31 are located entry tapers and smooth upper counterbore 35 and lower counterbore 36 so that sealing O-rings 52 and 66 can be engaged with and seal to the counterbores.

Tangential flow inlet 32 and corresponding alternate flow inlet 33 intersect the counterbores 35 and 36, respectively, of the body tube 31 with their coaxial inlet flow passages 37. Located in each counterbore 35, 36 is a short rectangular cross-section key 38 that has its long axis parallel to the body longitudinal axis. The keys 38 are used to engage with an alignment groove 65 of the spin housing, or spin can 60, in order to ensure that the tangential entry hole 64 of the spin housing will be aligned with the flow passages 37 of the flow inlets 32 and 33.

The end caps 50 are thick cylindrical sections with coaxial through holes 51 and a reduced diameter projection on their inner ends. The inner ends are provided with a male thread that can be engaged with the female thread of the tube 31. At the extreme inner end of each end cap 50 is a male O-ring groove mounting an O-ring 52 that seals between the end cap and the counterbore 35 or 36 of the tube 31. On the inner transverse face of each end cap 50 is a drilled and tapped regular hole circle in which studs 53 are mounted. Studs 53, which are only used in the upper end cap, project inwardly from the inner end of end cap 50 so that their axes are parallel to the axis of the end cap. On the outer transverse end of each end cap 50 is an annular groove 45 in which a gasket or metal seal ring 46 can be mounted. Additionally, the outer end cap has a regular circular pattern of drilled and tapped holes 44 by which studs can mounted. The hole circle 44 and the seal ring groove 45 are concentric with the through holes 51 of the end caps 50.

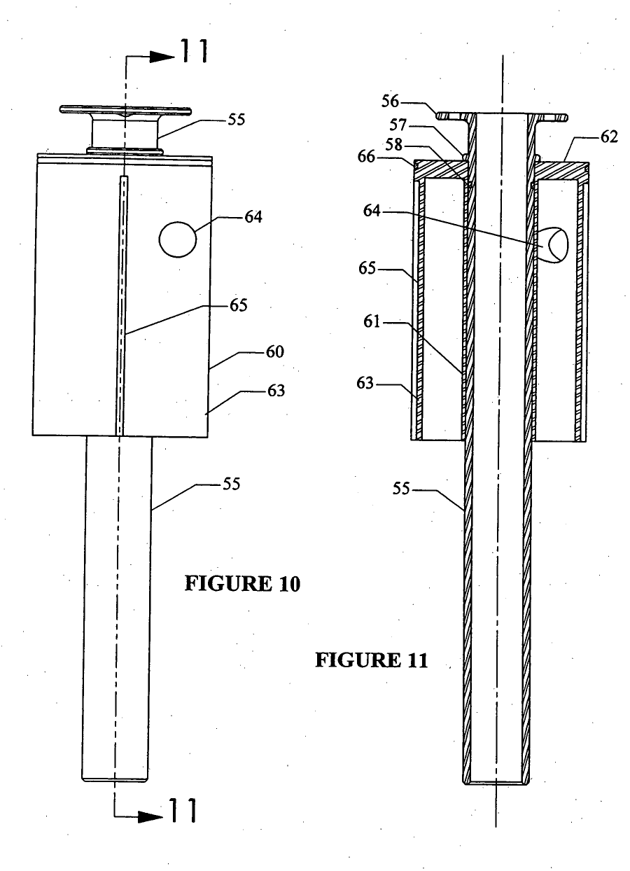

Outlet tube 55, seen best in FIGS. 10 and 11, consists of a right cylindrical tube that has a transverse flange 56 on its upper end. The flange 56 has a concentric regular clearance hole circular pattern corresponding to that on the inner transverse end of the end caps 50, so that the outlet tube 55 can be mounted thereto by means of studs 53 and retained by nuts 54 engaged with the studs. A short distance axially below the end flange 56 of outlet tube 55 is annular ridge 57, and then spaced a short distance below that is an annular male O-ring groove containing O-ring 58, which is able to seal to the bore of the spin can 60.

Spin can 60 consists of an inner right circular cylindrical tube 61, an outer right circular cylindrical tube 63, and an interconnecting transverse bulkhead 62 at the upper end of the spin can. The interior bore of inner tube 61 is a close fit to the exterior of outlet tube 55 and the annulus between the two tubes 55 and 61 is sealed by O-ring 58. The exterior of outer tube 63 is a close fit to either the upper counterbore 35 and the lower counterbore 36 of the tube 31. The exterior of spin can 60 has an annular male O-ring groove mounting O-ring 66 adjacent its upper end, so that the annulus between the spin can 60 and the tube 31 is sealed.

A tangential hole 64 penetrates the outer tube 63 so that fluid can be injected tangentially into the annular cavity 67 between the inner tube 61 and the outer tube 63 of the spin can 60. Spaced slightly below the O-ring groove on the exterior of the transverse bulkhead 62 of the spin can 60 are two diametrically opposed rectangular grooves 65 which are parallel to the longitudinal axis of the spin can and extend to its lower end. The grooves 65 are engagable by the keys 38 of tube 31 in order to ensure coaxial alignment of the tangential hole 64 of the spin can 60 relative to inlet passage 37 of the tube 31 of the hydrocyclone 30. The lower end of the outer tube 63 of spin can 60 abuts the interior end of counterbore 35 of tube 31 and is retained on its upper end by abutting the annular ridge 57 of the outlet tube 55. At a minimum, the exterior of the inner tube 61 and the interior of the outer tube 63 are hardfaced in order to resist abrasive wear by the solids entrained in the fluid entering the spin can 60. In some cases, the hole 64 and the lower face of the bulkhead 62 may also be hardfaced.

Referring to FIG. 9, when the hydrocyclone 30 is assembled, the outer annular region 40 of the hydrocyclone is a high velocity area where high centrifugal forces cause the relatively high density solids in the entering fluid to move to the outer wall of the bore of the tube 31. The region 41 closer to the longitudinal axis of the tube 31 is a region into which the fluid in the hydrocyclone migrates after its solids are spun out. The solid-free fluid is then free to exit the hydrocyclone 30 up the outlet tube 55. The spin velocities in the hydrocyclone reduce downwardly from the central portion of the tube 31, so the separated solids in the fluid region 40 can gradually fall to the bottom of the tube 31 and collect in the region 42. The fluid region 43 between the spin can 60, upper end cap 50, and the tube 31 is isolated by O-rings 52, 58, and 66 and hence is dead volume.

FIG. 12 is a horizontal partial cross-section through the flow axis of the normally closed heavy phase outlet components. When ball 99 of ball valve 82 is opened, then the heavy phase at the bottom end of the hydrocyclone 30 can pass through the ball valve 82 and into annular cylindrical entry chamber 96 of oilfield choke 83.

The body 90 of choke 83 is a heavy walled steel cube with a heavy cylindrical outlet end concentric projecting neck, mounting an outlet flange connection, perpendicular to the entry flow passage. On the cube face opposed to the outlet neck is a actuator end neck with a short cylindrical extension. A coaxial stepped through hole extends from the actuator end to the outlet end, with counterbored entry chamber 96 centrally located in the cube of body 90.

The entry flow passage into body 90 is radial to the axis of the long through hole extending from the actuator end to the outlet end of the body 90. Mounted in the bore of the through hole on the outlet end of cavity 96 are right circular annular cylindrical choke seat 91 and outlet liner 92. The seat is sealingly inserted into a counterbore immediately adjacent entry chamber 96, while the outlet liner is inserted sealingly into the outlet bore of the central passage. The flow passage from the chamber 96 to the outlet of the choke 83 is restricted by choke gate 93.

Choke gate 93 has an approximately cylindrical shape and is symmetrical about its transverse midplane. It may have internal flow passages connecting from one side to the other in order that it will not fluid lock and will be exposed to balanced opening forces when it is fully or nearly closed. Choke gate 93 is located on actuator rod 94, which extends from linear actuator 120. Nut 95 is mounted on the externally threaded actuator side neck of the body 90 and serves to retain the internal components of the choke, which include the choke gate 93 and the actuator rod 94, guiding assemblies, seals, and the like familiar to those skilled in the art. The actuator 120 may be manual or either electrically, hydraulically, or pneumatically operated. In most cases, the actuator 120 will be powered with a manual override. The portions of the choke exposed to high velocity flow are typically constructed of sintered tungsten carbide, a ceramic, or a hardfaced material.

### OPERATION OF THE INVENTION

In normal operation, the solids separation system 10 is brought to a location and temporarily connected between the wellhead outlet and the normal production processing equipment on the well location. The skid mounting 11 of the system eases the transportation and handling of the unitized system. The system is set upright with ball valve 82 blocking outflow of the heavy phase from the hydrocyclone. When the valve controlling the outflow from the wellhead is opened, the inlet ball valve 23 and outlet ball valve 74 are opened if they were not previously opened. This permits fluid produced from the well to enter the hydrocyclone 30, where the fluid is spun by the spin chamber due to its tangential entry. The centrifugal forces from the spinning action cause the relatively heavier solids entrained in the well fluids to migrate to the outer periphery of the spin can 60 and then into the tube 31, where they gradually fall to the lower collection region 42 of the housing. While this is occurring, the lower density fluid that carried the solids into the spin can 60 migrates radially inwardly while spinning and losing its solids. As the light phase fluid moves inwardly, it also flows downwardly enough to exit the hydrocyclone 30 by way of the outlet tube 55 and through ball valve 74 and the other components of the normal outflow circuit to the outlet line 76, and thence to the well production facilities. As the solids collect in the bottom end of the hydrocyclone, they are appreciably densified in comparison to the outflow from a conventional mud system hydrocyclone, although the solids are still saturated with well fluids.

When it is determined that the hydrocyclone has reached its capacity for solids containment, then choke 83 is closed and dump ball valve 82 is opened. Actuator 120 then slowly opens choke 83 so that the high pressure differential forces the solids in the collection region 42 in the bottom of the hydrocyclone 30 out through the choke. Since the mass of captured solids is highly porous, well fluid is with the solids, thereby fluidizing the solids to enhance the solids passage through the choke 83 and into the sump (not shown) via dump outlet line 84.

Proper control of the choke 83 ensures that dump fluid (with its entrained solids) passage through the choke causes a large enough pressure drop that the dumped fluid can be safely handled by the downstream solids storage. The excess fluid in the solids is separated by gravity settling. After emptying of the solids from the hydrocyclone, the ball valve 82 is reclosed and solids collection can be resumed. As is well understood by those skilled in the art, the dump line can be branched so that a reserve choke is in line if the first choke needs refurbishment. Upon job completion, the skidded unit is disconnected and removed from the well location.

### ADVANTAGES OF THE INVENTION

The present invention offers a safe, efficient, and cost effective means of solids removal from a high pressure well outflow. The system utilizes well understood and widely available hardware, such as the valves, fittings, and chokes employed. The unitizing of the system simplifies shipping and installation at a well site.

Use of the intermittent operation of the heavy phase dump circuit in conjunction with collection of the solids within the large volume hydrocyclone permits significant gains in solids consolidation over prior methods. Further, the excessive loss of desirable well fluids from continuous, rather than intermittent, operation is avoided. This is particularly important when the solids content of the produced fluid is not high.

The ability to invert the housing of the hydrocyclone and double the operating life of the hydrocyclone is a further advantage of the present invention. The hydrocyclone represents an expensive part of the solids separation system and doubling its effective operating life is a significant economic advantage of the present invention.

Although the present invention and its advantages have been described in detail, it should be understood that various changes, substitutions and alterations can be made herein without departing from the spirit and scope of the invention as defined by the appended claims.

What is claimed is:

1. A solids separation system comprising:
a material entry line;
an entry valve attached to the entry line;
a hydrocyclone comprising
a tubular body having a top end cap and a bottom end cap,
a first inlet proximal to the top end cap,
a spin can positioned within a top end of the tubular body below the top end cap, and
an outlet tube transversing the spin can;
a fluid outlet line having one end attached to the outlet tube;
a solids outlet line exiting a bottom end of the hydrocyclone;
a solids exit valve in fluid communication with the solids outlet line on a first end;
a choke in fluid communication with the solids outlet line when the solids exit valve is open; and
a solids exit line attached to the choke.

2. The solids separation system of claim 1, further comprising a fluid exit valve connected to the fluid outlet line on a first end and to a fluid exit line on a second end.

3. The solids separation system of claim 1, wherein the separation system is mounted is a skid frame.

4. The solids separation system of claim 1, wherein the entry valve is a ball valve.

5. The solids separation system of claim 6, wherein the ball valve is manually operated.

6. The solids separation system of claim 1, wherein the entry valve is a ball valve, a tapered plug valve, or a gate valve.

7. The solids separation system of claim 1, further comprising a second inlet proximal to the bottom end cap.

8. The solids separation system of claim 7, wherein the second inlet is in a mirror image location about the tubular body horizontal midplane.

9. The solids separation system of claim 8, wherein the second inlet is capped with a blind flange.

10. The solids separation system of claim 1, wherein an upper half of the tubular body is substantially similar to a lower half of the tubular body when the tubular body is rotated 180° about the longitudinal axis of the tubular body.

11. The solids separation system of claim 1, wherein the spin can has an entry aperture.

12. The solids separation system of claim 11, wherein the entry aperture of the spin can is aligned with the first inlet.

13. The solids separation system of claim 1, wherein the spin can comprises an inner cylindrical tube, an outer cylindrical tube and an interconnecting bulkhead.

14. The solids separation system of claim 13, wherein the outlet tube transverses the interior bore of the inner tube.

15. The solids separation system of claim 1, wherein the outlet tube extends into the tubular body below the spin can.

16. The solids separation system of claim 1, wherein the solids exit valve is a ball valve.

17. The solids separation system of claim 1, further comprising an actuator attached to the choke on an opposed side of the choke from the solids exit line.

18. The solids separation system of claim 17, wherein the choke has as a choke gate attached to a reciprocating actuator rod.

19. The solids separation system of claim 1, wherein the choke has a pressure balanced choke gate.

20. The solids separation system of claim 1, wherein the choke has a choke gate with at least one flow passage transversing the choke gate.

21. A solids separation system comprising:
a material entry line;
an entry valve attached to the entry line;
a hydrocyclone comprising
a tubular body having a top end cap and a bottom end cap,
a first inlet proximal to the top end cap,
a spin can positioned within a top end of the tubular body below the top end cap, and
an outlet tube transversing the spin can;
a fluid outlet line having one end attached to the outlet tube;
a solids outlet line exiting a bottom end of the hydrocyclone;
a solids exit valve in fluid communication with the solids outlet line on a first end;
a choke in fluid communication with the solids outlet line when the solids exit valve is open;
a solids exit line attached to the choke; and
an actuator attached to the choke on an opposed side of the choke from the solids exit line.

22. The solids separation system of claim 21, further comprising a fluid exit valve connected to the fluid outlet line on a first end and to a fluid exit line on a second end.

23. The solids separation system of claim 21, further comprising a second inlet proximal to the bottom end cap.

24 The solids separation system of claim 23, wherein the second inlet is in a mirror image location about the tubular body horizontal midplane.

25 The solids separation system of claim 24, wherein the second inlet is capped with a blind flange.

26. The solids separation system of claim 21, wherein an upper half of the tubular body is substantially similar to a lower half of the tubular body when the tubular body is rotated 180° about the longitudinal axis of the tubular body.

27. The solids separation system of claim 21, wherein the spin can has an entry aperture.

28. The solids separation system of claim 27, wherein the entry aperture of the spin can is aligned with the first inlet.

29. The solids separation system of claim 21, wherein the spin can comprises an inner cylindrical tube, an outer cylindrical tube and an interconnecting bulkhead.

30. The solids separation system of claim 29, wherein the outlet tube transverses the interior bore of the inner tube.

31. The solids separation system of claim 21, wherein the outlet tube extends into the tubular body below the spin can.

32. The solids separation system of claim 21, wherein the choke has as a choke gate attached to a reciprocating actuator rod.

33. The solids separation system of claim 21, wherein the choke has a choke gate with at least one flow passage transversing the choke gate.

34. A solids separation system comprising:
a material entry line;
an entry valve attached to the entry line;
a hydrocyclone comprising
a tubular body having a top end cap and a bottom end cap,
a first inlet proximal to the top end cap,
a spin can positioned within a top end of the tubular body below the top end cap, the spin can having an aperture aligned with the first inlet, and
an outlet tube transversing the spin can and extending into the tubular body below the spin can;
a fluid outlet line having one end attached to the outlet tube;
a fluid exit valve connected to the fluid outlet line on a first end and to a fluid exit line on a second end
a solids outlet line exiting a bottom end of the hydrocyclone;
a solids exit valve in fluid communication with the solids outlet line on a first end;
a choke in fluid communication with the solids outlet line when the solids exit valve is open;
a solids exit line attached to the choke; and
an actuator attached to the choke on an opposed side of the choke from the solids exit line.

35. The solids separation system of claim 1, further comprising a second inlet proximal to the bottom end cap of the tubular body.

36 The solids separation system of claim 35, wherein the second inlet is in a mirror image location about the tubular body horizontal midplane.

37. The solids separation system of claim 35, wherein the second inlet is capped with a blind flange.

38. The solids separation system of claim 34, wherein an upper half of the tubular body is substantially similar to a lower half of the tubular body when the tubular body is rotated 180° about the longitudinal axis of the tubular body.

39. The solids separation system of claim 34, wherein the choke has a choke gate with at least one flow passage transversing the choke gate.

40. A process for removing solid particles from flowing fluids, the process comprising the steps of:
(a) connecting a wellhead outlet and a fluid entry line of a solids separation system, the solids separation system comprising
(i) an entry valve attached to the entry line,
(ii) a hydrocyclone having
a tubular body having a top end cap and a bottom end cap,
a first inlet proximal to the top end cap,
a spin can positioned within a top end of the tubular body below the top end cap, and
an outlet tube transversing the spin can;
(iii) a fluid outlet line having one end attached to the outlet tube,
(iv) a solids outlet line exiting a bottom end of the hydrocyclone,
(v) a solids exit valve in fluid communication with the solids outlet line on a first end,
(vi) a choke in fluid communication with the solids outlet line when the solids exit valve is open, and
(vii) a solids exit line attached to the choke;
(b) connecting the fluid outlet line to a fluid handling facility;
(c) opening the entry valve to allow fluid flowing from the wellhead into the spin can of the hydrocyclone;
(d) routing a departicularized fluid from the outlet tube through the fluid outlet line and into the fluid handling facility;
(e) collecting a settlement of solid particles at the bottom end of the hydrocyclone;
(f) closing the choke;
(g) opening the solids exit valve whenever the settlement of solid particles reaches a predetermined amount;
(h) opening the choke slowly to remove most of the settlement of solid particles; and
(i) closing the solids exit valve once most of the settlement of solid particles has been removed from the bottom end of the hydrocyclone.
